(19) United States
(12) Patent Application Publication
(10) Pub. No.: US 2010/0058090 A1
(43) Pub. Date: Mar. 4, 2010

(54) STORAGE SYSTEM AND POWER SAVING METHOD THEREOF

(76) Inventors: Satoshi Taki, Kawasaki (JP); Takeshi Umezuki, Kawasaki (JP)

Correspondence Address: STAAS & HALSEY LLP, SUITE 700, 1201 NEW YORK AVENUE, N.W., WASHINGTON, DC, 20005, US

(21) Appl. No.: 12/550,593

(22) Filed: Aug. 31, 2009

(30) Foreign Application Priority Data
Sep. 2, 2008 (JP) 2008-224989

(51) Int. Cl. G06F 12/16; G06F 1/32

(52) U.S. Cl. 713/324; 711/114; 711/E12.103; 711/154

(57) ABSTRACT

A storage system and method are provided. The storage system includes, redundant disk arrays to which the same data is written and a write/read control section which controls writing and reading of data to and from the redundant disk arrays in response to a write request and a read request. The system includes disk rotation control section which continuously rotates disks of one of the disk arrays to perform a read process for written data and stops the rotation of disks of the other disk array when writing of data to the redundant disk arrays is completed, and further stops, when the write/read control section determines that the frequency of read requests from the host apparatus becomes less than a predetermined value after the completion of the writing of data, the rotation of the disks of the one of the disk arrays in accordance with the determination.

### CROSS-REFERENCE TO RELATED APPLICATIONS

This application is related to and claims priority to Japanese Patent Application No. 2008-224989, filed on Sep. 2, 2008, and incorporated herein by reference.

### BACKGROUND

1. Field

The embodiments herein are directed to a storage system and a power saving method thereof.

2. Description of the Related Art

Archive storage systems are data recording systems having a WORM (Write Once Read Many) structure. In the archive storage system, therefore, data once written cannot be overwritten. Accordingly, the archive storage system is suitable for recording e-mails, contracts, and the like because falsification of data can be prevented.

The archive storage system uses RAID (Redundant Array of Independent Disks) which can manage disks at high speed and with high reliability. RAID is a technology which uses a plurality of hard disks to distribute data or make data redundant for improving processing performance as well as realizes data recording reliably. In the archive storage system, a pair of RAIDs, one of which is called a primary RAID, and the other of which is called a secondary RAID, are used to duplicate data for further completely backing up the data.

Data requested to be written is written simultaneously to the pair of RAIDs. In response to a read request, data is read from one of the RAIDs which is previously determined, for example, the primary RAID. When the pair of RAIDs become full due to the writing of data, a new pair of RAIDs which are previously prepared are used to write data.

In such a storage system, all disks keep rotating so as to rapidly and reliably cope with a write process and a read process. Accordingly, the storage system is a problem in attempts at reducing the power consumption of the system.

### SUMMARY

It is an aspect of the embodiments discussed herein to provide a storage system including redundant disk arrays to which the same data can be written, a write/read control section which is capable of controlling writing and reading of data to and from the redundant disk arrays in response to a write request and a read request from a host apparatus and a disk rotation control section which is capable of continuously rotating disks of one of the disk arrays to perform a read process for written data and stops the rotation of disks of the other disk array when writing of data to the redundant disk arrays is completed, and further stops, when the write/read control section determines that the frequency of read requests from the host apparatus becomes less than a predetermined value after the completion of the writing of data, the rotation of the disks of the one of the disk arrays in accordance with the determination.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates an exemplary embodiment example of a storage system.

FIG. 2 illustrates operation of an exemplary embodiment realizing power saving.

FIG. 3 illustrates operation of an exemplary embodiment realizing power saving.

FIG. 4 illustrates operation of an exemplary embodiment realizing power saving.

FIG. 5 illustrates an exemplary embodiment using RAID units which are different in level.

FIG. 6 illustrates a case of dividing RAID units into a plurality of power supply areas and stopping power supply to the power supply area.

### DETAILED DESCRIPTION OF EMBODIMENTS

Exemplary RAIDs Include:

RAID 0: A process called “striping” can be performed in which data is divided into block units to be distributed and written across a plurality of hard disks. Reading of data can be performed simultaneously in parallel from the plurality of hard disks so that a high data transfer speed can be provided.

RAID 1: A process called “mirroring” can be performed in which data is written simultaneously across a plurality of disks. When one of the disks fails, another disk can be automatically replaced by the failed disk to process data. Therefore, the operation continues as it is. The loss of data or stop of the system due to a disk failure does not occur.

RAID 4: Striping similar to that of RAID 0 is performed. That is, data is divided into block units to be recorded across a plurality of data disks. Further, parity for detecting and correcting data error is used. Parity is generated by exclusive ORing the divided blocks and recorded in one disk dedicated to parity. Even when one piece of the divided data is broken, the broken data can be restored based on the generated parity.

RAID 5: Similarly to RAID 4, data is divided into block units to be recorded across a plurality of disks. However, parity is distributed across the plurality of disks in order to prevent a parity disk from becoming a bottleneck in processing.

RAID 6: Similarly to RAID 5, data is divided into block units to be recorded across a plurality of disks. In RAID 6, two kinds of parity are distributed across the plurality of disks. Accordingly, the failure of up to two disks can be recovered.

RAID can be used in a combination of different RAID levels. For example, RAID can be used by the appropriate combination of level 0 and level 1, level 5 and level 0, level 5 and level 1, and so on. RAID used in exemplary embodiments may be RAID 0 to RAID 6 or the combination of them.

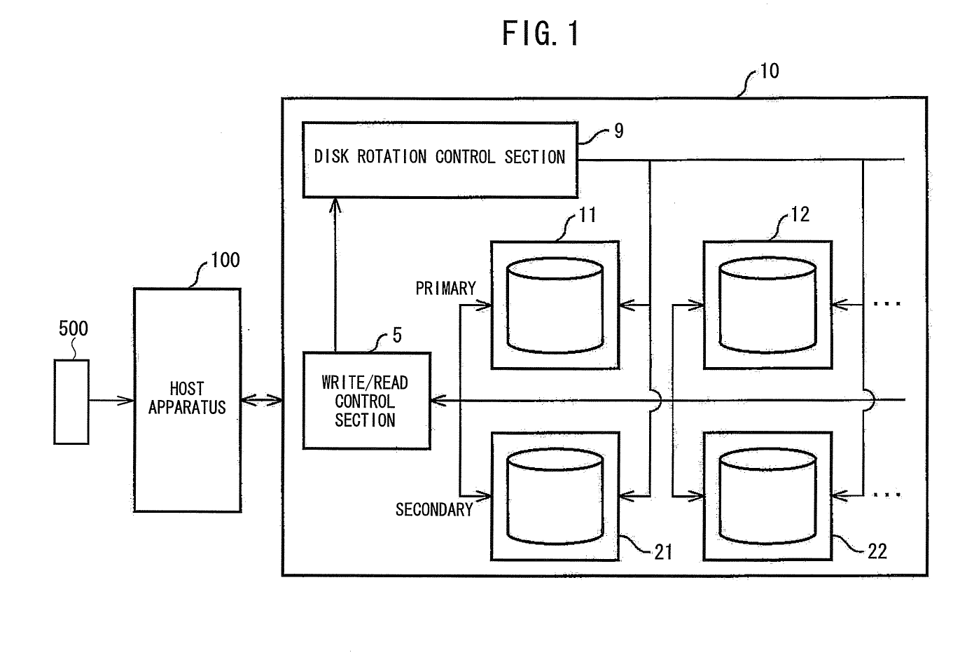

FIG. 1 illustrates an exemplary embodiment of a storage system.

A storage system 10 of the embodiment includes RAID units 11, 12, 21, and 22, in which in each a plurality of hard disks are configured as a certain level RAID. The number of RAID units illustrated in FIG. 1 may be varied is, and as many RAID units may be provided as necessary for recording data.

RAID units 11 and 12 are RAID units on a primary side. On the other hand, RAID units 21 and 22 are RAID units on a secondary side.

The same data can be written to the primary RAID unit 11 and the secondary RAID unit 21 to duplicate the data.

RAID levels employed by the primary RAID unit and the secondary RAID unit may be different.

A write/read control section 5 can enable the primary RAID unit and the secondary RAID unit to execute a process for writing or reading in response to a write request or a read request from a host apparatus 100. Further, the write/read control section 5 sends information on the status of the RAID unit to a disk rotation control section 9.

The disk rotation control section 9 can stop power supply to a disk motor (not-shown) of the RAID unit to stop the rotation of the disks based on the information sent from the write/read control section 5. A time for waiting a data transfer request from a host apparatus can be measured to stop rotation of a disk when the waiting time reaches a predetermined time or more, for suppressing the power consumption. Power consumption can be suppressed by stopping the rotation of the disks.

The host apparatus 100 requests the storage system 10 to write or read data. The host apparatus 100 includes an information processor such as a server or a PC (Personal Computer). A computer-readable recording media 500 may read by the host apparatus 100.

In the storage system 10, in response to a write request from the host apparatus 100, the write/read control section 5 writes data requested to be written simultaneously to the RAID units 11 and 21. When the RAID units 11 and 21 become full, the write/read control section 5 writes data requested to be written simultaneously to the RAID units 12 and 22. When the RAID units 12 and 22 become full, data is written to another primary RAID unit and secondary RAID unit (both not-shown). The numbers of primary RAID units and secondary RAID units can be appropriately determined depending on the scale of the storage system.

Since the same data is recorded in the primary RAID unit and the secondary RAID unit, it is possible to set the data to be read from one of the units when reading. According to an exemplary embodiment, the RAID units 11 and 12 on the primary side are set to process a read request.

A recording medium for storing data is not limited to a hard disk as long as it is a disk rotated by a motor. A magneto-optical disk or an optical disk can be used instead of a hard disk.

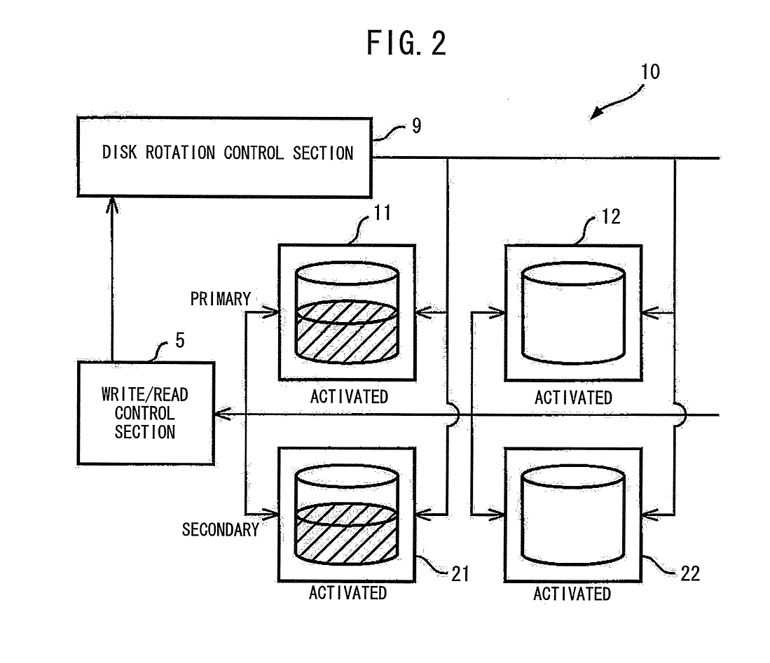

FIGS. 2 to 4 illustrate a method of power saving method according to an exemplary embodiment. In the storage system 10 illustrated in FIG. 2, the same data has been written to the RAID units 11 and 21 according to the control of the write/read control section 5. The RAID units 11 and 21 still have free space. Data has not been written to the RAID unit 12 and the RAID unit 22. However, since it is necessary to start writing data to the RAID units 12 and 22 immediately after the RAID unit 11 and the RAID unit 21 become full, the RAID units 12 and 22 have been activated, and disks of the RAID units 12 and 22 are rotating.

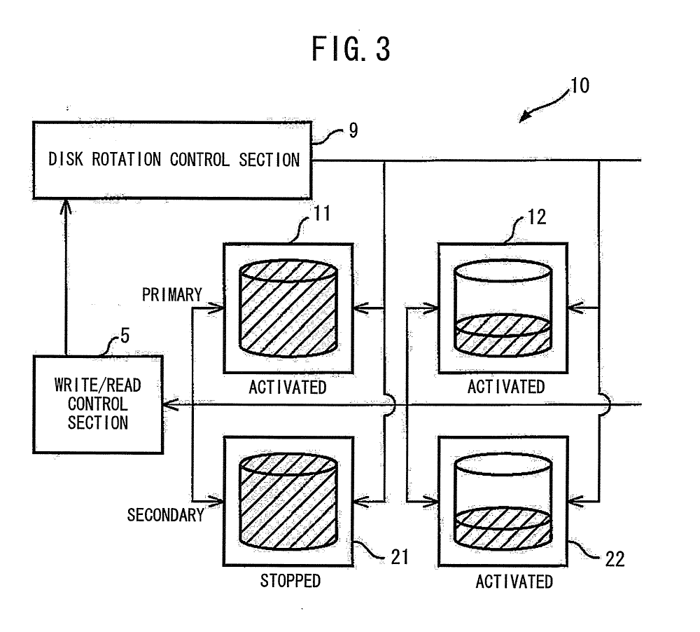

FIG. 3 illustrates the writing of data to the RAID units 11 and 21 has been completed, and the same data is being written to the RAID unit 12 and the RAID unit 22. When the writing of data to the RAID units 11 and 21 is completed, the write/read control section 5 notifies the disk rotation control section 9 of the completion of the writing of data to the RAID units 11 and 21. Since it has been previously determined that the RAID unit 11 as the primary RAID unit processes the reading of data, the disk rotation control section 9 maintains the activated status of the RAID unit 11. At the same time, the disk rotation control section 9 stops power supply to a disk rotation motor of the RAID unit 21 as the secondary RAID unit to stop the rotation of the disks.

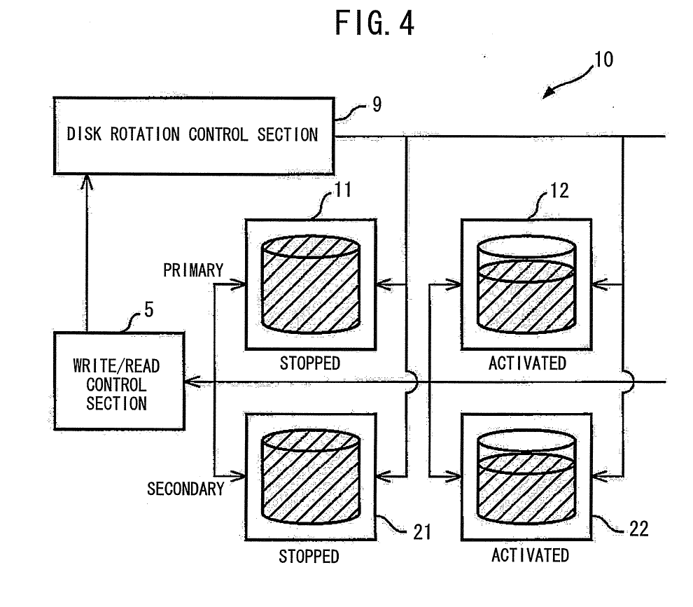

FIG. 4 illustrates the status of the storage system after a lapse of further time from the status illustrated in FIG. 2. As illustrated in FIG. 4, the rotation of the disks of the primary RAID unit 11 in which the writing has been completed is also stopped.

In general, many read requests are issued for written data in a short time after the writing to the RAID units 11 and 21 is completed. Accordingly, the RAID unit 11 on the primary side has many opportunities to execute a read process. However, the number of read requests may be reduced as time has elapsed, so that the frequency of executions of read process is decreased. An archive device having a WORM function aims to store data once stored therein for a long time. That is, the archive device does not always store data especially because the written data is scheduled to be read. Accordingly, in the storage system of the embodiment, the frequency of executions of read process is further decreased along with a lapse of time after writing compared with a general RAID device. Accordingly, if the frequency of read processes is less than a threshold value, the rotation of the disks of the RAID unit 11 in which the disks keep rotating for reading can be stopped without a significant influence.

For example, the write/read control section 5 measures a time elapsed from a previous read process. If no new read process is performed after a lapse of a predetermined time, the write/read control section 5 determines that the frequency of read processes is decreased. The write/read control section 5 notifies the disk rotation control section 9 of the fact that the frequency of read processes is decreased. The disk rotation control section 9 stops the rotation of the disks of the RAID unit 11 based on the information from the write/read control section 5.

A technique for determining that the frequency of read processes is decreased is not restrictive. For example, the number of times of read process is measured within a range of a predetermined time to determine the number of times of read process per unit time. The determined number of times of read process may be compared with a reference value, whereby it can be determined that the frequency of read processes is decreased.

Further, the disks of the RAID unit 11 may be set to stop rotating when a certain time has elapsed since the writing to the RAID units 11 and 21 was completed. The time from the completion of writing to the stop of rotation of the disks may be obtained by statistically analyzing the operation of the storage system.

If failure has occurred in the primary RAID unit 11 to eliminate redundancy as a feature of RAID when writing data to the RAID units 11 and 21, the write/read control section 5 can set the secondary RAID unit 21 as a RAID which responds to a read request. After setting the RAID unit 21 as the RAID which responds to a read request, the disk rotation control section 9 stops the rotation of the disks of the RAID unit 11 when the writing to the RAID units 11 and 21 has been completed. On the other hand, the disk rotation control section 9 maintains the activated status of the RAID unit 21 for performing a read process. If the write/read control section 5 determines that the frequency of read processes becomes less than the reference value, the disk rotation control section 9 stops the disk rotation of the RAID unit 21.

While the secondary RAID unit 21 responds to a read request from the host apparatus, a process for restoring the redundancy of the primary RAID unit 11 can be executed. In the primary RAID unit 11, for example, it is set to use a spare disk, or the failed disk is replaced, so that the redundancy can be restored. Since the process for restoring the redundancy of the primary RAID unit 11 is performed while the secondary RAID unit 21 responds to a read request from the host apparatus, there is no influence on processing. In addition, the process for restoring the redundancy of the primary RAID unit 11 can be performed by activating the primary RAID unit 11 which remains stopped after the secondary RAID unit 21 is stopped.

When emphasis is placed more on power saving than on the performance of a read process, a setting can be made such that power supply to the RAID unit 11 as the primary RAID unit is stopped, in addition to the secondary RAID unit 21, upon changing the write disk, to stop the rotation of the disks of the RAID unit 11.

While data is being written to the RAID units 11 and 21, power supply to the RAID units 12 and 22 on standby is stopped to stop the disk rotation of the RAID units 12 and 22. The rotation of the disks of the RAID units 12 and 22 may be started when the time to start using the RAID units 12 and 22 approaches.

When the RAID units 11 and 21 are operating, the disks of the RAID units 12 and 22 which are scheduled to operate next remain unrotated. When the write/read control section 5 detects that the write area of the disks of the RAID units 11 and 21 under operation becomes less than, for example, 30%, the write/read control section 5 notifies the disk rotation control section 9 of the fact that the write process of the RAID units 11 and 21 is nearly completed. The disk rotation control section 9 supplies power to the disks of the RAID units 12 and 22 which are scheduled to operate based on the information from the write/read control section 5.

The power supply may be s stopped while considering the operation status of the redundant RAID units, whereby power saving can be achieved.

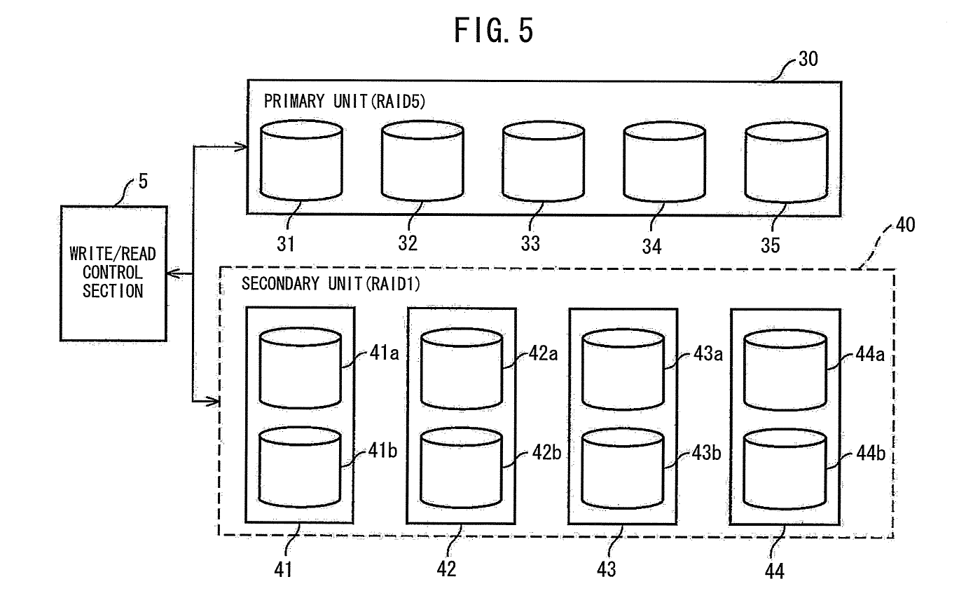

FIG. 5 illustrates a case where RAIDs which are different in level are used for storing data redundantly. In FIG. 5, a RAID unit 30 on a primary side conforms to RAID 5, and a RAID unit 40 on a secondary side conforms to RAID 1. In FIG. 5, reference numerals 30 and 40 denote RAID units, and reference numerals 31 to 35 and reference numerals 41a and 41b to 44a and 44b denote physical disks. Although not illustrated in FIG. 5, a storage system may be configured in the same manner as in FIG. 1. The RAID unit 30 in FIG. 5 may correspond to the RAID unit 11 in FIG. 1, and the RAID unit 40 in FIG. 5 may correspond to the RAID unit 21 in FIG. 1.

In the primary RAID unit 30 of RAID 5, data is divided into blocks, and the respective blocks are written simultaneously in parallel across different disks 31 to 35. When writing, parity is generated. The generated parity is distributed and stored across the disks. Even if one of the disks fails, the data written to the failed disk can be restored by using the generated parity. When reading, the plurality of disks 31 to 35 are simultaneously accessed to read the data all at once.

The secondary RAID unit 40 has RAID devices 41 to 44 of RAID 1. The RAID devices 41 to 44 respectively include two disks 41a and 41b to 44a and 44b, and the same data is written to the two disks.

In the embodiment, four disks of data can be written to each of the RAID units 30 and 40. The primary RAID unit 30 includes five disks in order to reserve capacity for parity information which is distributed and stored.

In response to a write request from the host apparatus, the same data is written to the primary RAID unit 30 and the secondary RAID unit 40.

In the primary RAID unit 30, the respective divided data blocks are written simultaneously in parallel across the disks 31 to 35 together with the generated parity.

In the secondary RAID unit 40, data is first written to the RAID device 41. That is, the same data is written to the disks 41a and 41b. When the RAID device 41 becomes full, data is written to the RAID device 42.

In this manner, when four disks of data are written to the primary RAID unit 30 and the secondary RAID unit 40, data is written to the next primary RAID unit and secondary RAID unit (both not-illustrated).

When the writing to the primary RAID unit 30 and the secondary RAID unit 40 is completed, the disks of one of the RAID units are continuously driven for processing a read request, and the rotation of the disks of the other RAID unit is stopped.

In an exemplary e embodiment, in order to determine which of the RAID units is to be continuously driven and which of the RAID units is to stop the rotation of the disks, the storage system itself statistically analyzes a read pattern of data handled by the storage system. As a result, the storage system autonomously determines the RAID unit to be continuously rotary-driven and the RAID unit to stop rotating.

If there are many sequential accesses as the result of analyzing the read pattern of data, the primary RAID unit 30 of RAID 5 is continuously driven to perform a read process. The rotation of the disks of the secondary RAID unit 40 of RAID 1 is stopped. Since data is read simultaneously from a plurality of disks, RAID 5 has a high sequential access performance. Accordingly, RAID 5 is suitable for processing sequential access.

If there are many random accesses as the result of statistically analyzing the read pattern of data, the secondary RAID unit 40 of RAID 1 is continuously driven to perform a read process. The rotation of the disks of the primary RAID unit 30 of RAID 5 is stopped.

If there are many random accesses, and if a disk on which accesses are concentrated is specified, the rotation of the disks other than the specified disk can be stopped in the unit 40 of RAID 1. Therefore, power saving efficiency can be further enhanced.

The write/read control section 5 may statistically analyze the read pattern of data to determine the RAID unit to be continuously rotary-driven and the RAID unit to stop rotating. This determination is sent from the write/read control section 5 to the disk rotation control section 9. The disk rotation control section 9 continuously rotates the disks of the RAID unit to be continuously driven and stops the rotation of the disks of the RAID unit to be stopped based on the received information.

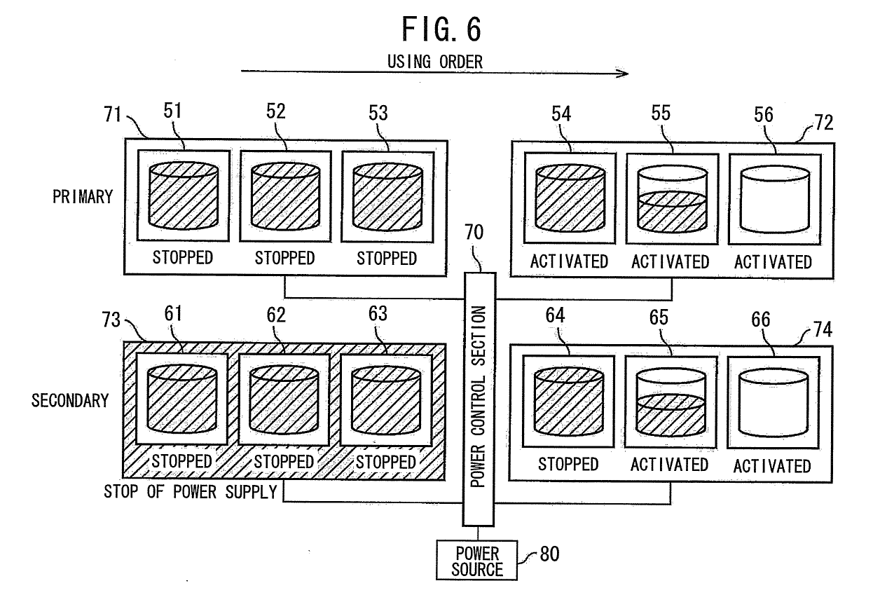

FIG. 6 illustrates a method for improving power saving by dividing RAID units on a primary side and RAID units on a secondary side into a plurality of power supply areas.

RAID units 51 to 56 are arranged on the primary side, and the RAID units 51 to 53 are arranged in a first power supply area 71. The RAID units 54 to 56 are arranged in a second power supply area 72.

RAID units 61 to 66 are arranged on the secondary side, and the RAID units 61 to 63 are arranged in a third power supply area 73. The RAID units 64 to 66 are arranged in a fourth power supply area 74.

A power control section 70 can supply power and stop supplying power from a power source 80 to the first to fourth power supply areas 71 to 74 independently of one another.

The RAID units 51 to 56 on the primary side and the RAID units 61 to 66 on the secondary side which respectively correspond thereto are made into pairs, respectively, and the same data is written to the paired RAID unit. In FIG. 6, writing has been completed for the paired RAID units 51 and 61, RAID units 52 and 62, RAID units 53 and 63, and RAID units 54 and 64. Data is being written to the RAID units 55 and 65, and the RAID units 56 and 66 are on standby.

The storage system including the RAID units in FIG. 6 is the same as that in FIG. 1. For example, the RAID units 51 and 52 in FIG. 6 correspond to the RAID units 11 and 12 in FIG. 1, and the RAID units 61 and 62 in FIG. 6 correspond to the RAID units 21 and 22 in FIG. 1.

In the exemplary embodiment, the RAID units on the primary side perform a read process in response to a read request of data. On the primary side, the RAID unit 54 is activated among the units in which the writing of data has been completed, and the RAID units 51 to 53 stop the rotation of the disks.

On the other hand, as illustrated in FIG. 6, all of the RAID units 61 to 63 on the secondary side in the power supply area 73 stop the rotation of the disks when data recording is completed. Further, the power control section 70 stops power supply to all of the RAID units 61 to 63 in the power supply area 73, whereby they cannot use any power. The RAID units 61 to 63 are separated from the storage system, and power supply is stopped.

In the embodiment, when all of the RAID units in the power supply area stop the rotation of the disks, they are separated from the storage system, and the power control section stops any power supply. Accordingly, this may achieve more power saving than the case of stopping the disk rotation of the individual RAID units.

When failure has occurred in the disks of the RAID units 51 to 53 on the primary side to eliminate redundancy, it may be preferable to avoid accessing the primary side. In this case, power is supplied to the power supply area 73 on the secondary side for which power supply has been stopped through the power control section, whereby the secondary side RAID units 61 to 63 which have been stopped can be activated to cope with the situation. The power control section 70 stops power supply to the power supply area 71 to which the failed RAID unit on the primary side belongs, whereby power saving can be achieved.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A storage system comprising:
redundant disk arrays to which the same data is written;
a write/read control section which controls writing and reading of data to and from the redundant disk arrays in response to a write request and a read request from a host apparatus; and
a disk rotation control section which continuously rotates disks of one of the disk arrays to perform a read process for written data and stops the rotation of disks of the other disk array when writing of data to the redundant disk arrays is completed, and further stops, when the write/read control section determines that the frequency of read requests from the host apparatus becomes less than a predetermined value after the completion of the writing of data, the rotation of the disks of the one of the disk arrays in accordance with the determination.

2. The storage system according to claim 1, wherein
the write/read control section determines that the frequency of read requests becomes less than the predetermined value if there is no read request even when a predetermined time has elapsed since a previous read process.

3. The storage system according to claim 1, wherein
each of the redundant disk arrays is a RAID.

4. The storage system according to claim 3, wherein
one of the redundant disk arrays is a RAID of a certain level, and the other redundant disk array is a RAID of a different level from the one of the disk arrays.

5. The storage system according to claim 4, wherein
the RAID of a certain level is RAID 5, and the RAID of a different level is RAID 1.

6. The storage system according to claim 4, wherein
the write/read control section executes a statistical analysis on a read pattern of the data and determines which one of the disk arrays is to execute the read process based on the statistical analysis on the read pattern.

7. The storage system according to claim 6, wherein
the statistical analysis on the read pattern determines whether the read pattern belongs to sequential access or random access.

8. The storage system according to claim 1, wherein
when the one of the disk arrays has no redundancy, the write/read control section reads data from the other disk array.

9. The storage system according to claim 1, further comprising:
a plurality of power supply areas; and
a power control section which supplies power and stops supplying power to each of the power supply areas independently of one another, wherein
the redundant disk arrays are divided into a plurality of parts, the plurality of parts of the divided disk arrays being respectively arranged in the plurality of power supply areas, and
when all disks arranged in one of the plurality of power supply areas are in a rotation stop state, the power control section stops supplying any power to the power supply area.

10. A power saving method of a storage system including redundant disk arrays to which the same data is written, and a disk rotation control section which controls the rotation of disks of the redundant disk arrays, the method comprising:
continuously rotating disks of one of the disk arrays to perform a read process for written data and stopping the rotation of disks of the other disk array when writing of data to the redundant disk arrays is completed, and
stopping the rotation of the disks of the one of the disk arrays when the frequency of read requests from a host apparatus becomes less than a predetermined value.

11. The power saving method of the storage system according to claim 10, wherein
it is determined that the frequency of read requests becomes less than the predetermined value if there is no read request even when a predetermined time has elapsed since a previous reading process.

12. The power saving method of the storage system according to claim 10, wherein
each of the redundant disk arrays is a RAID.

13. The power saving method of the storage system according to claim 12, wherein
one of the redundant disk arrays is a RAID of a certain level, and the other redundant disk array is a RAID of a different level from the one of the disk arrays.

14. The power saving method of the storage system according to claim 13, wherein
the RAID of a certain level is RAID 5, and the RAID of a different level is RAID 1.

15. The power saving method of the storage system according to claim 14, further comprising:
executing a statistical analysis on a read pattern of the data and determining which one of the disk arrays is to execute the read process based on the statistical analysis on the read pattern.

16. The power saving method of the storage system according to claim 15, wherein
the statistical analysis on the read pattern determines whether the read pattern belongs to sequential access or random access.

17. The power saving method of the storage system according to claim 10, wherein
when the one of the disk arrays has no redundancy, data is read from the other disk array.

18. A power saving method performed by a processor, comprising:
rotating disks of disk arrays of a storage system to perform a read process; and
stopping the rotation of one of the disk arrays when a frequency of read requests is less than a predetermined value.
